(19) United States
(12) Patent Application Publication
(10) Pub. No.: US 2005/0186936 A1
(43) Pub. Date: Aug. 25, 2005

(54) WIRELESS PERIPHERAL AND RELATED SYSTEM CAPABLE OF INDICATING WIRELESS CONNECTION STATUS WITH ALARM

(76) Inventor: Chien-Yi Shih, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/709,847

(22) Filed: Jun. 1, 2004

(30) Foreign Application Priority Data
Feb. 19, 2004 (TW) 093104141

(51) Int. Cl. H04M 3/00

(52) U.S. Cl. 455/404.1; 455/567; 455/557

(57) ABSTRACT

A wireless system has a host and a wireless peripheral, such as a cell phone and a corresponding wireless handset. When the system is in use, if a wireless connection between the host and the peripheral is disconnected, the wireless peripheral is capable of alerting a user by sound, light or vibration alarm. In addition, the host is capable of generating sound, light or vibration to indicate its location when it is disconnected.

### BACKGROUND OF INVENTION

1. Field of the Invention

The present invention provides a wireless peripheral and related system, and more particularly, a wireless system capable of indicating wireless connection status with an alarm.

2. Description of the Prior Art

With more and more development in wireless communication, substantial lines have been eliminated between a host and a wireless peripheral, such as between a mobile phone with a wireless headset (i.e. a Bluetooth wireless headset), or a computer with a wireless keyboard or a wireless mouse.

When using the above wireless systems, a user can move freely with a wireless peripheral as long as it remains within a wireless signal transmission range. However, if a host and a wireless peripheral is disconnected, the user cannot be aware of whether there is no signal to be exchanged or it is disconnected. That is, a prior art wireless peripheral cannot alarm a user if the original connection is disconnected. For example, if a user talks to another with a mobile phone having a prior art wireless headset, the user may not know if the wireless headset is out of the transmission range, or if the mobile phone is out of power.

### SUMMARY OF INVENTION

The claimed invention provides a wireless system, which can generate sound, light, or vibration as an alarm signal when the original connection between a host and a wireless peripheral is disconnected.

The invention also provides a wireless peripheral for a host. The wireless peripheral includes a wireless module for communicating wireless signals with the host, an alarm module for generating an alarm signal while receiving a control signal, and a decision module between the alarm module and the wireless module. When the wireless signal between the wireless module and the host is disconnected, the decision module generates the control signal to the alarm module for generating the alarm signal.

These and other concepts of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 to FIG. 3 illustrate three block diagrams of the present invention.

### DETAILED DESCRIPTION

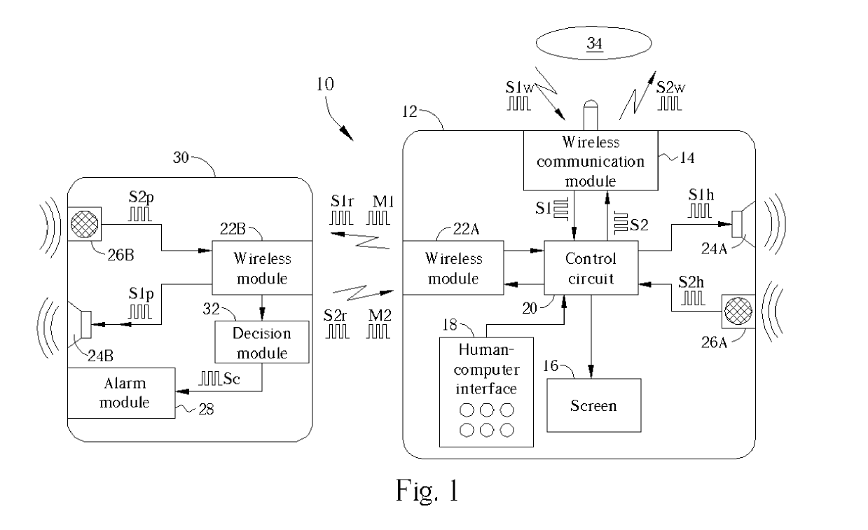

Please refer to FIG. 1, which illustrates a block diagram of a present invention mobile phone wireless system 10. The mobile phone wireless system 10 includes a host 12, such as a mobile phone, and a wireless peripheral 30, such as a wireless headset (headset) module. The host 12 includes a control circuit 20, a wireless communication module 14, a wireless module 22A for communicating wireless signals with the wireless peripheral 30, a speaker 24A, a microphone 26A, a screen 16 and a human-computer interface 18. The wireless peripheral 30 includes a wireless module 22B, a speaker 24B, and a microphone 26B, a decision module 32, and an alarm module 28.

In the host 12, the human-computer interface 18 connected to the control circuit 20 includes a plurality of buttons for receiving controls from a user, and generating corresponding signals. The wireless communication module 14 transmits/receives wireless signals through a wireless communication network 34. The speaker 24A transforms electric signals to sound, while the microphone 26A transforms sound to electric signals. In the wireless peripheral 30, the wireless module 22B sets up a wireless connection through the wireless module 22A of the host 12. Generally, the commonly available transmission methods are code division multiple access (CDMA) or Bluetooth. However, the invention does not limit the available transmission methods.

Besides, the speaker 24B of the wireless peripheral 30 transforms electric signals provided by the wireless module 22B to sound, while the microphone 26B transforms sound to electric signals for the wireless module 22B. Moreover, the decision module 32 of the wireless peripheral 30 can check whether the host 12 is connected by referring to the wireless module 22B, and the alarm module 28 can generate corresponding sound, light, or vibration as an alarm signal while the host 12 is disconnected.

When the user communicates with another through the wireless system 10 in the wireless communication network 34, the wireless communication module 14 decodes a received voice signal S1w to an electric voice signal S1. Without the wireless peripheral 30, the voice signal S1 is directly transformed to a voice signal S1h through the control circuit 20 for begin played from the speaker 24A. Furthermore, the microphone 26A transforms the received user's voice into an electric voice signal S2h. Then, the control circuit 20 transforms the voice signal S2h to a signal S2 for the wireless communication module 14, where the signal S2 is transformed to a wireless voice signal S2w for the wireless communication network 34. On the other hand, with the wireless peripheral 30, the processing module 56 transmits the voice signal S1 to the wireless module 22A for generating a wireless voice signal S1r for transmission to the wireless peripheral 30 through the wireless module 22B.

The voice signal S1r received by the wireless module 22B of the wireless peripheral 30 is transformed into an electric voice signal S1p, which is further transformed into sound by the speaker 24B. Moreover, a sound received in the microphone 26B is transformed into an electric voice signal S2p for the wireless module 22B to transform to a voice signal S2r for the wireless module 22A. The wireless module 22A transforms the voice signal S2r into an electric voice signal S2 for the processing module 56 to transmit to the wireless communication module 14, which transmits the voice signal S2w to the wireless communication network 34. Therefore, the voice signals S1r and S2r can be seen as service signals for accessing the wireless peripheral and the host.

The decision module 32 can determine connection status between the wireless peripheral 30 and the host 12. When the connection is disconnected, the decision module 32 generates a control signal Sc for the alarm module 28 (which can include a vibrator, a light-emitting device, a screen, or a speaker) to generate sound, light, or vibration as an alarm signal. In one embodiment, the alarm module 28 can play alarm sounds through the speaker 24B of the wireless peripheral 30.

As to determination of the connection, if the wireless module 22B of the wireless peripheral 30 receives the voice signal S1r provided by the host 12 sequentially, the decision module 32 determines that the connection is active. Oppositely, if the host 12 does not exchange the voice signals S1r and S2r with the wireless peripheral 30 (such as when the user turns on the wireless peripheral 30 but has no incoming call, or when a short silence during a conversation), the host 12 starts to exchange connection control packets M1 and M2 (as shown in FIG. 1) with the wireless peripheral 30 for determining the connection status. Furthermore, the host 12 can exchange the connection control packets M1, M2 and the voice signals S1r, S2r with the wireless peripheral 30 at the same time, which can decrease complexities of hardware/firmware/software of the wireless system 10. In this case, the connection control packets M1 and M2 are to check the connection status, so that the connection control packets M1 and M2 do not carry any voice data as the voice signals S1r and S2r. In general, present wireless protocols (such as the Bluetooth wireless communication protocol) have indicated some standard data formats for the connection control packets, so the present invention can follow such a format for checking the connection status.

In addition, after the user turns on the wireless peripheral 30, the host 12 starts to exchange the connection control packets M1 and M2 with the wireless peripheral 30 cyclically. That is, regardless of transmission of the voice signals S1r and S2r, the host 12 always exchanges the connection control packets with the wireless peripheral 30 cyclically after the wireless peripheral 30 is active. In general, the connection control packets M1 and M2 can be short packets, so that the voice signals S1r and S2r will not be subject to interference.

As to the connection control packets, the decision module 32 of the wireless peripheral 30 determines the connection status according to intervals of the received connection control packet M1 provided by the host 12 cyclically. For example, if the host 12 emits the connection control packet M1 every cycle T, but the wireless peripheral 30 has not yet received the connection control packet M1 for some cycles T, the decision module 32 triggers the alarm module 28 to generate the alarm signal. The decision rule of the decision module 32 can be set properly in the present invention because the wireless system 10 may have lost a few of the connection control packets, while the connection is still active. Moreover, in this situation (the host 12 emits the connection control packet M1), the decision module 32 can determine the connection status only according to the received connection control packets M1 rather than the connection control packet M2 provided by the wireless peripheral 30. Besides, other than cyclic emission of the connection control packets M1, the host 12 can emit the connection control packets M1 to the wireless peripheral 30 during a predetermined duration.

Except for the above-mentioned method, the present invention further could detect whether the number of the received signals in the host is smaller than a predetermined number during a duration. If the number of the received signals is smaller than the predetermined number, the connection status is unavailable (which is briefly similar with the disconnection status), and then the present invention could trigger an alarm signal for alerting.

Also, the wireless peripheral 30 can emit a connection control packet M2 as response to the connection control packet M1 provided by the host 12, or, contrarily, the host 12 can emit the connection control packet M1 as response to the connection control packet M2 provided by the wireless peripheral 30, where the decision module 32 determines the connection status with the received response.

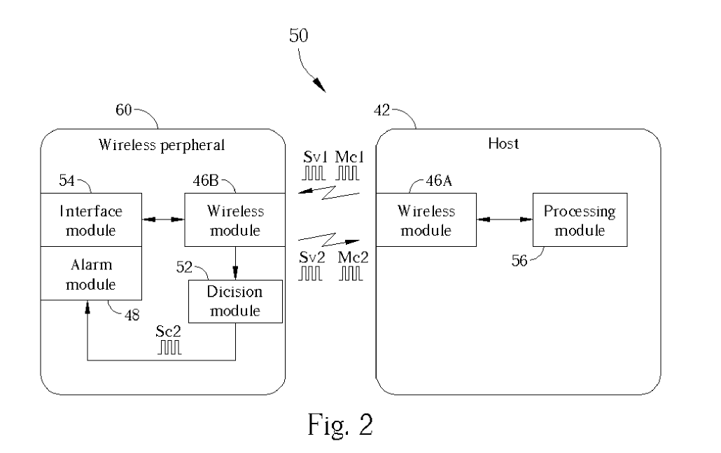

Please refer to FIG. 2, which illustrates a block diagram of the present invention adopted in a wireless system 50. The wireless system 50 includes a host 42 and a wireless peripheral 60. The host 42 includes a processing module 56 and a wireless module 46A. The wireless peripheral 60 includes a wireless module 46B, an interface module 54, a decision module 52, and an alarm module 48. The processing module 56 controls the host 42. The wireless modules 46A and 46B can establish a wireless connection between the host 42 and the wireless peripheral 60 for exchanging service signals Sv1 and Sv2. An interface module 54 of the wireless peripheral 60 can be a human-computer interface for emitting light, sound, or vibration, and for receiving controls from a user. The host 42 can be a computer, and the wireless peripheral 60 can be a wireless keyboard, mouse, or other wireless devices, such as a wireless monitor.

The host 42 and the wireless peripheral 60 can exchange wireless connection control packets Mc1 and Mc2, so that the decision module 52 can determine the connection status between the host 42 and the wireless peripheral 60 according to the connection control packets. If it is disconnected, the decision module 52 triggers the alarm module 48 emitting alarm signals with a control signal Sc2. For example, if the interface module 54 includes a monitor, the alarm module 48 can indicate the disconnection by displaying specific words, notations, etc. on the monitor.

In addition to emitting the alarm signals when the connection is disconnected, the decision module can also emit revival signals when the connection returns to being active, so that the user is aware of the connection status with the alarm signals and the revival signals. Besides, the decision module and the alarm module can include controllers (such as buttons) for suppressing the alarm signal or the revival signal.

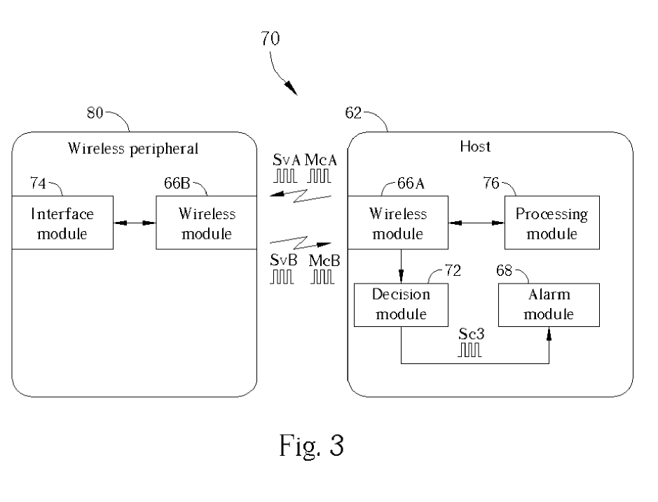

Moreover, a host of the present invention can include a decision module and an alarm module for emitting alarm signals from the host. Please refer to FIG. 3, which illustrates a block diagram of a present invention wireless system 70. The wireless system 70 includes a host 62 and a wireless peripheral 80. The host 62 includes a wireless module 66A, a processing module 76, a decision module 72, and an alarm module 68, while the wireless peripheral 80 includes an interface module 74 and a wireless module 66B. The processing module 76 controls the host 62. The wireless modules 66A and 66B build up a wireless connection between the host 62 and the wireless peripheral 80 with service signals SvA and SvB. The interface module 74 provides for a user to control the host 62.

The wireless modules 66A and 66B determine the connection status according to connection control packets McA and McB. If the connection status is not acceptable, the decision module 72 triggers the alarm module 68 to emit light, sound, or vibration as an alarm signal with a control signal Sc3. Similar to the embodiments in FIG. 2 and FIG. 3, the alarm module 68 can emit the alarm signal with an interface of the host 62.

In FIG. 3, the wireless peripheral 80 can emit the connection control packet McB as response to the connection control packet McA provided by the host 62, or, contrarily, the host 62 can emit the connection control packet McA as response to the connection control packet McB provided by the wireless peripheral 80, where the decision module 72 determines the connection status with the received response.

The host and the wireless peripheral in FIG. 2 or FIG. 3 can include independent decision modules and alarm modules, so that the wireless peripheral reminds the user about the disconnection, and the host emits alarm signals for being located or for reminding a user about low power.

Those skilled in the art will readily observe that numerous modifications and alterations of the device may be made while retaining the teachings of the invention. Accordingly, the above disclosure should be construed as limited only by the metes and bounds of the appended claims.

1. A wireless peripheral for a host comprising:
a wireless module for communicating wireless signals with the host;
an alarm module for generating an alarm signal while receiving a control signal; and
a decision module between the alarm module and the wireless module; wherein when the wireless module and the host is disconnected, the decision module generates the control signal to the alarm module for generating the alarm signal.

2. The wireless peripheral of claim 1 wherein the wireless peripheral is a wireless headset, the format of the alarm signal being one of the following: sound, light, vibration, or a combination of such.

3. The wireless peripheral of claim 1 wherein the host is capable of transmitting a voice signal to the wireless module, the wireless peripheral further connecting to an interface module for transforming the voice signal into an analog voice; the interface module generating an alarm sound while the alarm module receives the control signal.

4. The wireless peripheral of claim 1 wherein the host is capable of transmitting confirmation signals at different times; the decision module generating the control signal to the alarm module if the decision module has not received the confirmation signals for a predetermined time.

5. The wireless peripheral of claim 1 wherein the host is capable of transmitting confirmation signals at different times; the decision module generating the control signal to the alarm module if a number of the confirmation signals received in the decision module is smaller than a predetermined number for a predetermined time.

6. The wireless peripheral of claim 1 wherein the host transmits confirmation signals by the following methods: regularly sending, irregularly sending, or their combination.

7. The wireless peripheral of claim 1 wherein the host transmits confirmation signals only when no other signals are to be transmitted to the wireless peripheral.

8. The wireless peripheral of claim 1 wherein the host is capable of transmitting a service signal, the wireless peripheral further comprising an interface module for transferring the service signal received in the wireless module into sound, vibration, or image.

9. The wireless peripheral of claim 8 wherein the host transmits the confirmation signal only when not transmitting the service signal.

10. The wireless peripheral of claim 1 wherein the wireless module is capable of transmitting request signals at different times, the host transmitting a confirmation signals for responding to the request signals.

11. A wireless system comprising:
a wireless peripheral; and
a host comprising:
a wireless module for communicating wireless signals with the wireless peripheral;
an alarm module for generating an alarm signal while receiving a control signal; and
a decision module between the alarm module and the wireless module; wherein when the wireless module and the host is disconnected, the decision module generates the control signal to the alarm module for generating the alarm signal.

12. The wireless peripheral of claim 11 wherein the host is capable of transmitting confirmation signals at different times; the decision module generating the control signal to the alarm module if the decision module has not received the confirmation signals for a predetermined time.

13. The wireless peripheral of claim 11 wherein the host is capable of transmitting confirmation signals at different times; the decision module generating the control signal to the alarm module if a number of the confirmation signals received in the decision module is smaller than a predetermined number for a predetermined time.

14. The wireless peripheral of claim 11 wherein the host transmits confirmation signals by the following methods: regularly sending, irregularly sending, or their combination.

15. The wireless peripheral of claim 11 wherein the host transmits confirmation signals only when no other signals are to be transmitted to the wireless peripheral.

16. The wireless peripheral of claim 11 wherein the wireless module is capable of transmitting a request signal at different times, the host transmitting a confirmation signal for responding to the request signal.

17. A method for a wireless system, the wireless system comprising a host and a wireless peripheral, the host capable of communicating wireless signals with the wireless peripheral; the method comprising:
communicating wireless signals between the host and the wireless peripheral; and
when the wireless communication between the host and the wireless peripheral is disconnected, generating an alarm signal with the wireless peripheral.

18. The method of claim 17 further comprising:
transmitting confirmation signals at different times with the host; and
determining that the wireless communication between the host and the wireless peripheral is disconnected if the confirmation signals are not received in a predetermined time.

19. The method of claim 17 further comprising:
transmitting confirmation signals at different times with the host; and
determining that the wireless communication between the host and the wireless peripheral is disconnected if a number of the received confirmation signals is smaller than a predetermined number over a predetermined time.

20. The method of claim 17 further comprising:
transmitting request signals at different times with the wireless peripheral; and
transmitting confirmation signals for responding to the request signal with the host.
